(19) United States
(12) Patent Application Publication
(10) Pub. No.: US 2023/0251019 A1
(43) Pub. Date: Aug. 10, 2023

(54) REFRIGERATOR WITH DUAL SWING DOOR

(71) Applicant: FURRION, LLC, Elkhart, IN (US)

(72) Inventors: Wayne Kaylor, White Pigeon, MI (US); Christopher S. Greer, Syracuse, IN (US)

(21) Appl. No.: 17/666,719

(22) Filed: Feb. 8, 2022

(51) Int. Cl. F25D 23/02; E05D 7/02

(52) U.S. Cl. CPC F25D 23/028; E05D 7/02

(57) ABSTRACT

An enclosure has a door that can be opened from one of two sides by the operation of one of two handles that extend along opposing vertical sides of the door. Each handle can move corresponding upper and lower latch bars that allow that same side of the door to be selectively released from one set of hinge pins that are affixed to the enclosure and allow the door to pivot about another set of hinge pins on the opposite side. Guide pins on the hinge side engage arcuate guide channels as the door pivots, preventing the door from being detached once pivoted about one of the axes. When the latch bars are moved to the release position on one side, the latch bars on the opposite side are prevented from being moved to the release position at the same time.

### BACKGROUND OF THE INVENTION

The present disclosure relates to enclosures with swinging doors, in particular refrigerated compartments such as coolers, refrigerators, and freezers. Except for French door or side-by-side door configurations, commercially available refrigerator/freezers with swinging doors can be opened from one side only. Frequently these can be configured to swing from the opposite side but switching between hinge sides usually involves unscrewing fasteners and moving hardware and brackets to allow this change. After the change, the refrigerator remains in that configuration until the hardware and brackets are moved again. Changing back and forth is impractical and does not allow flexibility. Others have attempted to solve this problem by allowing the door to swing from either the left side or right side, such as what is covered by U.S. Pat. No. 3,889,419 or U.S. Pat. No. 5,548,927, but these involve complex and problematic mechanisms and can be visually unappealing. An improved and more appealing design is needed.

### SUMMARY OF THE INVENTION

The present disclosure describes a refrigerator/freezer with doors that can be opened from either side. The door has a release handle along each longitudinal side that is moveable between a resting position and a displaced position. Moving the release handle on one side moves latch bars that release a first set of hinge pins from the door, allowing that side of the door to be opened. When opened, the door pivots on a second set of hinge pins located on the opposite side. As the door pivots to the opened position, guide pins move into guide channels on the opposite side of the door. Both sides are prevented from being released at the same time by latch bars on one side that contact latch bars on the opposite side if both are moved to the release position at the same time.

### BRIEF DESCRIPTION OF THE DRAWINGS

FIG. 1 is an isometric view of the refrigerator;

FIG. 2 is an isometric view of the refrigerator in FIG. 1 with the top door opened from one side and the bottom door opened from the other side;

FIG. 3 is a partial exploded bottom isometric view with the bottom door removed and top door spaced from the refrigerator cabinet;

FIG. 4 is a partial exploded top isometric view of the refrigerator shown in FIG. 3 showing the bottom door;

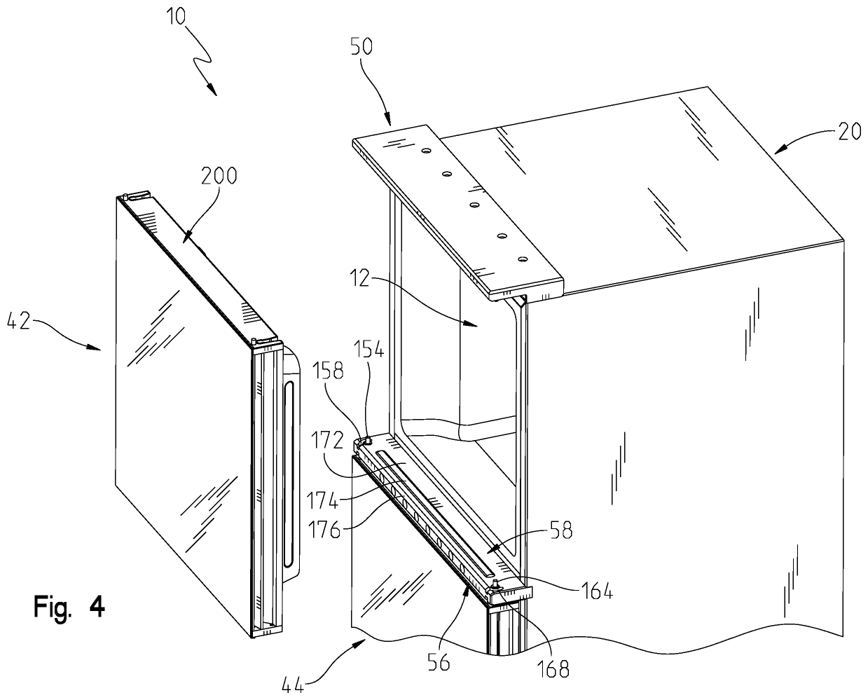

FIG. 5 is a partial top isometric view of the refrigerator shown in FIG. 3;

FIG. 6 is a bottom section view 6-6 of the refrigerator shown in FIG. 3;

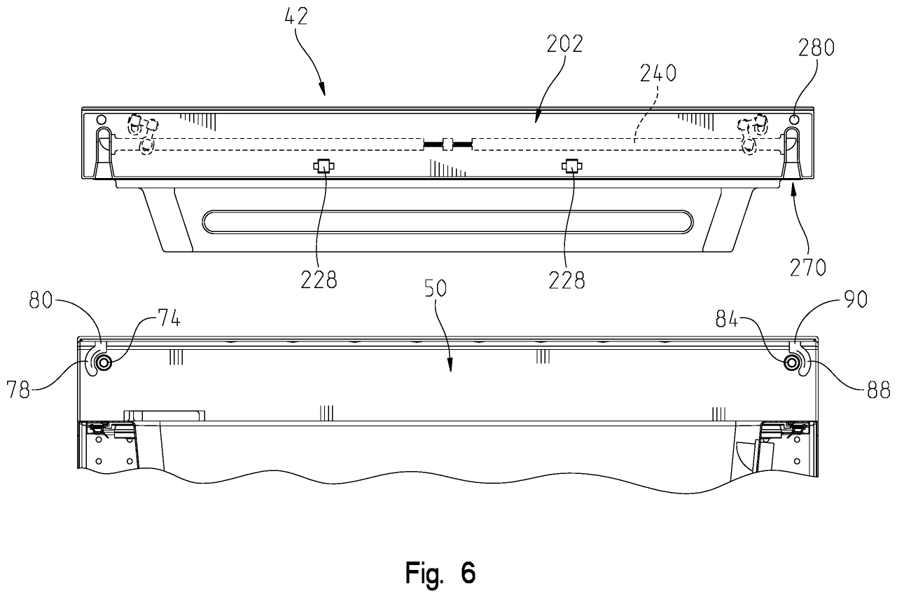

FIG. 7 is an exploded bottom isometric view of a lower latch assembly in the top door;

FIG. 8 is a bottom view of the lower latch assembly in FIG. 7;

FIG. 9 is a top section view 9-9 of the top door in FIG. 1;

FIG. 10 is a bottom isometric section view 10-10 of the top door in FIG. 1;

FIG. 11 is a bottom isometric section view 10-10 of the top door in FIG. 1 with the release handle moved away from the resting position;

FIG. 12 is a top isometric section view 10-10 of the refrigerator in FIG. 1;

FIG. 13 is a partial side section view 13-13 of the refrigerator in FIG. 1;

FIG. 14 is a partial side section view 14-14 of the refrigerator in FIG. 1; and

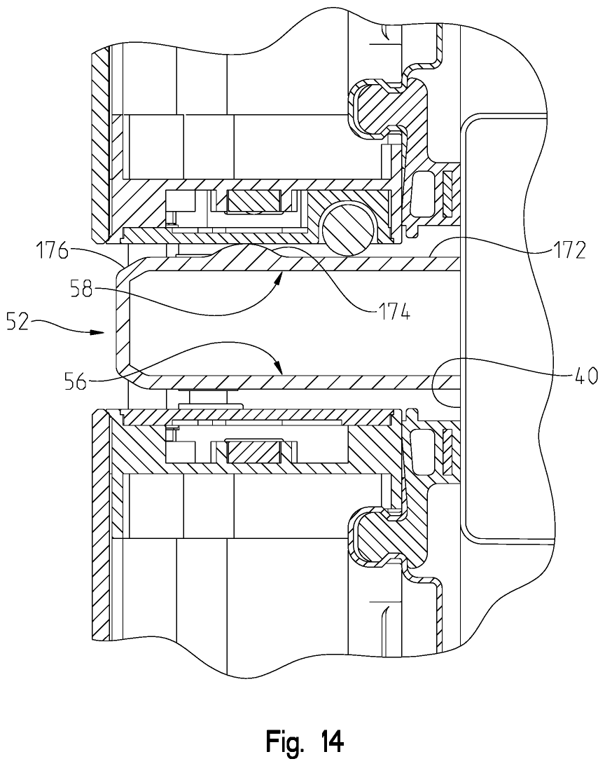

FIG. 15 is a partial top section view 15-15 of the refrigerator in FIG. 2 with the door components in broken lines.

### DESCRIPTION OF THE PREFERRED EMBODIMENT

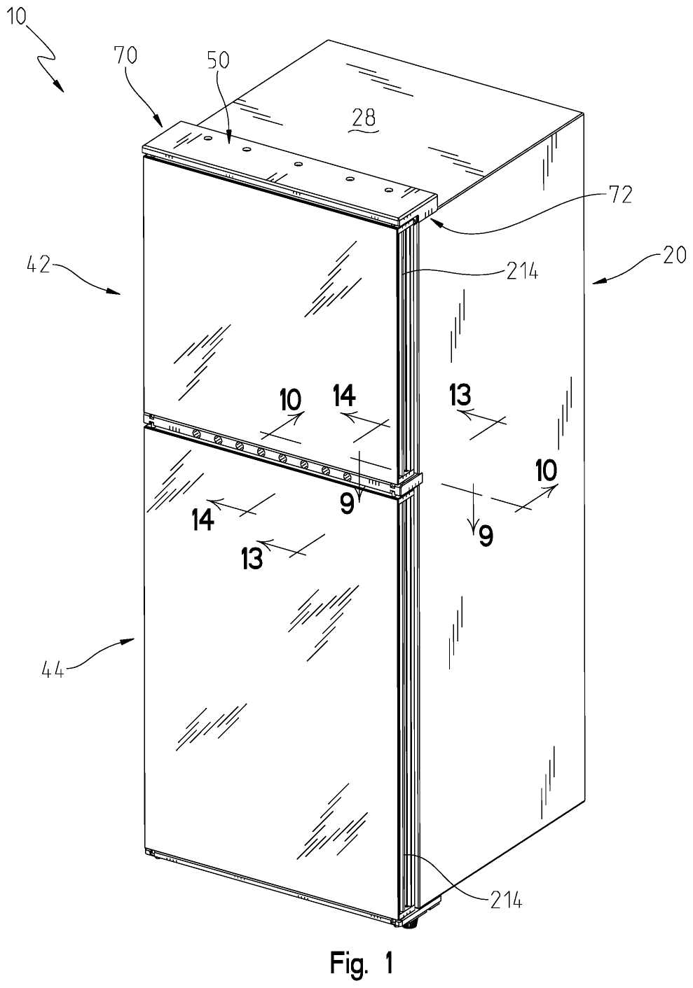

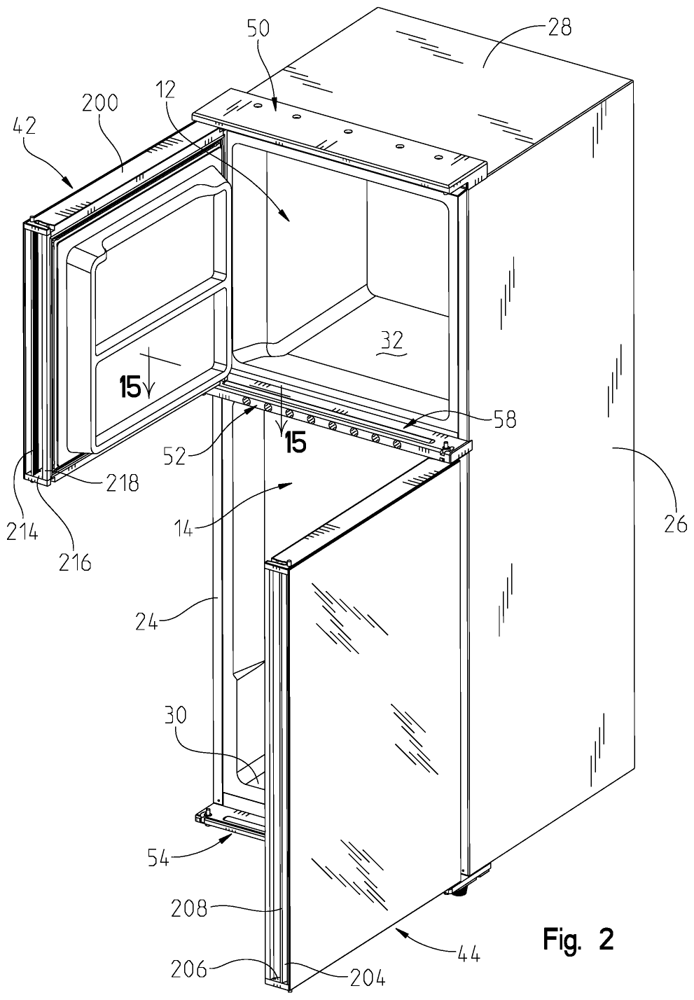

A dual-swing refrigerator 10 shown in FIGS. 1 and 2 has a freezer compartment 12 on top with a refrigerated compartment 14 located below it, but other configurations are contemplated, such as a single door or the freezer being located underneath the refrigerator. It is further contemplated that one of the compartments could be a “French door” style with the other compartment utilizing the dual-swing mechanism discussed in further detail below. As is known in the art with refrigerators, freezers, and other devices that control the temperature of an insulated internal cavity, the refrigerator 10 shown herein utilizes a compressor or equivalent to remove heat from inside the compartments 12, 14.

The compartments 12, 14 as shown in FIG. 2 are located in a cabinet 20. The cabinet 20 has a rear wall 22, side walls 24, 26, a top wall 28, and a bottom wall 30. In the embodiment shown herein, an intermediate wall 32 extends between the side walls to separate the compartments 12, 14. The side walls 24, 26, top wall 28, bottom wall 30, and intermediate wall 32 all cooperate to form a front surface 40 where doors 42, 44 seal to the cabinet 20 when closed. In FIG. 1, the doors 42, 44 are shown in the latched position, while in FIG. 2, the doors 42, 44 are shown in the opened position, with each pivoting about different axes. Affixed to the cabinet 20 and adjacent the compartments 12, 14 are hinge blocks 50, 52, 54. Upper hinge block 50 is affixed to the top wall 28 and the lower hinge block 54 is affixed to the bottom wall 30. Intermediate hinge block 52 is affixed to the intermediate wall 32. As will be explained in further detail below, the upper and lower hinge blocks 50, 54 are single-sided and the intermediate hinge block 52 is double sided. The hinge blocks 50, 52, 54 are used to secure the doors 42, 44 and allow them to pivot on one of two hinge axes 76, 86. In particular, the upper hinge block 54 mates with the upper door 42, the lower hinge block 54 mates with the lower door 44, and the intermediate hinge block 52 mates with both doors 42, 44.

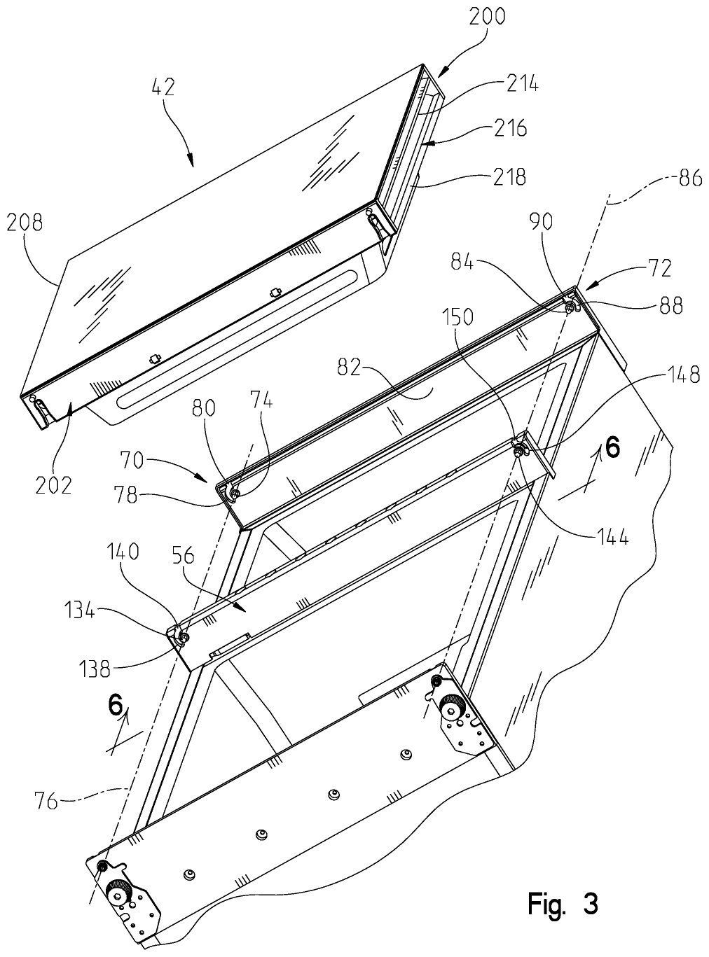

As shown in FIG. 3, the upper hinge block 50 has a first (left) side 70 and a second (right) side 72 which are mirror symmetrical. The first side 70 has a first hinge pin 74 that is affixed to the hinge block 50 and located on a first hinge axis 76. A first arcuate guide channel 78 has a radius centered on the first hinge axis 76 and partially encircles the first hinge pin 74. The first arcuate guide channel 78 has an opening 80 that is a straight path outwardly from one end of the first guide channel. A flat surface 82 extends across the upper hinge block 50 with the guide channel 78 recessed therefrom and the first hinge pin 74 protruding therefrom. The second side 72 has a second hinge pin 84 that is located on a second hinge axis 86. A second arcuate guide channel 88 has a radius centered on the second hinge axis 86 and partially encircles the second hinge pin 84. The second guide channel has an opening 90 that is a straight path outwardly from one end of the second guide channel. As is shown in the FIGS, the guide channels 78, 88 are spaced further from each other than the hinge pins 74, 84.

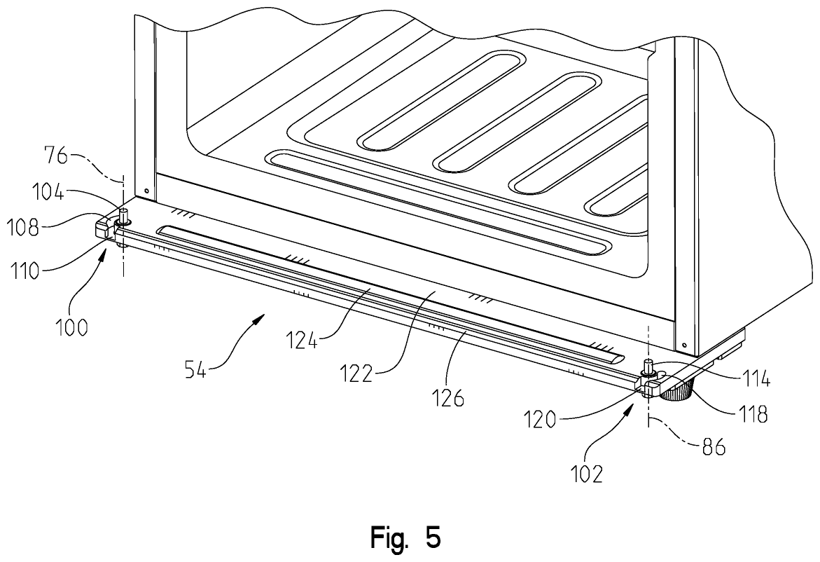

As shown in FIG. 5, the lower hinge block 54 has a first (left) side 100 and a second (right) side 102 which are mirror symmetrical. The first side 100 has a first hinge pin 104 that is located on the first hinge axis 76 and also includes a first arcuate guide channel 108 and opening 110. The second side 102 has a second hinge pin 114 located on the second hinge axis 86 and also includes a second arcuate guide channel 118 and opening 120. In addition to the sides 100, 102, the lower hinge block 54 has a support surface 122 that extends between the sides 100, 102. The support surface 122 includes an elongate domed protrusion 124. A lead-in surface 126 is parallel to the domed protrusion 124 and breaks the corner of the support surface 122.

The intermediate hinge block 52 combines the features of the upper hinge block 50 and lower hinge block 54 with the under side 56 having hinge pins 134, 144 on hinge axes 76, 86 and guide channels 138, 148 with corresponding openings 140, 150. The upper side 58 has hinge pins 154, 164 on hinge axes 76, 86 and guide channels 158, 168 with corresponding openings 160, 170. The upper side 58 also includes a support surface 172 that extends between sides 152, 162. The support surface 172 includes an elongate domed protrusion 174 and lead-in surface 176.

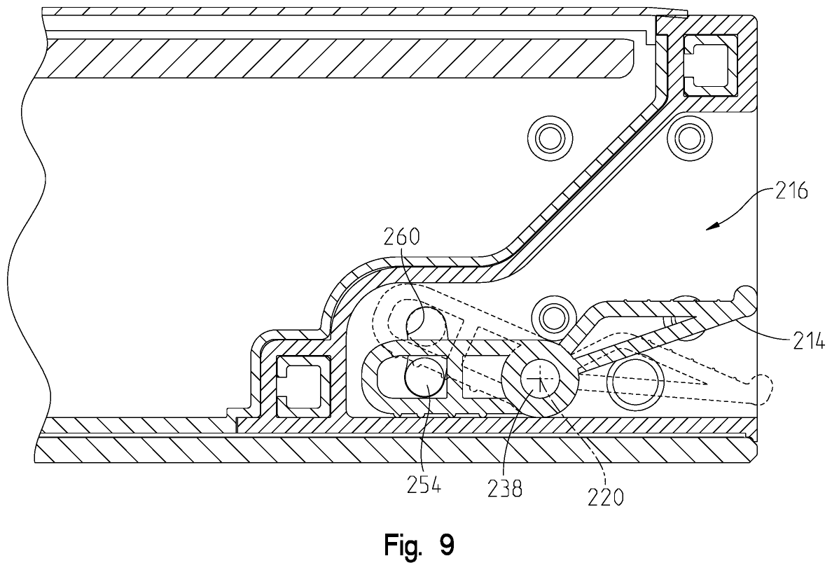

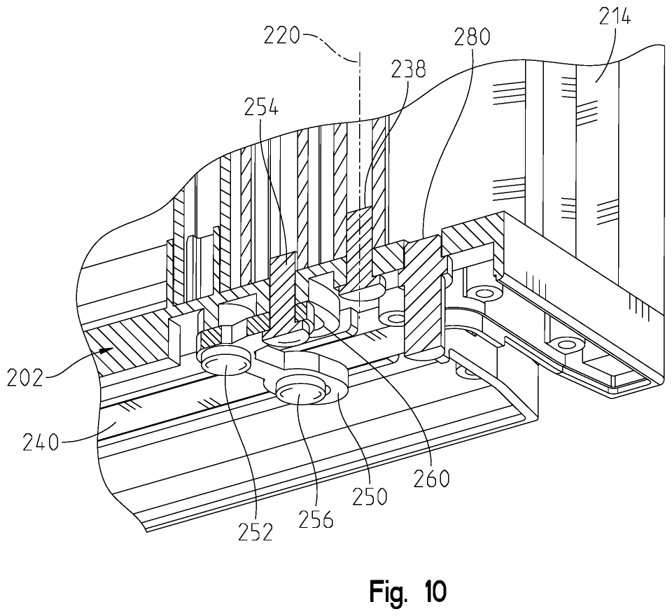

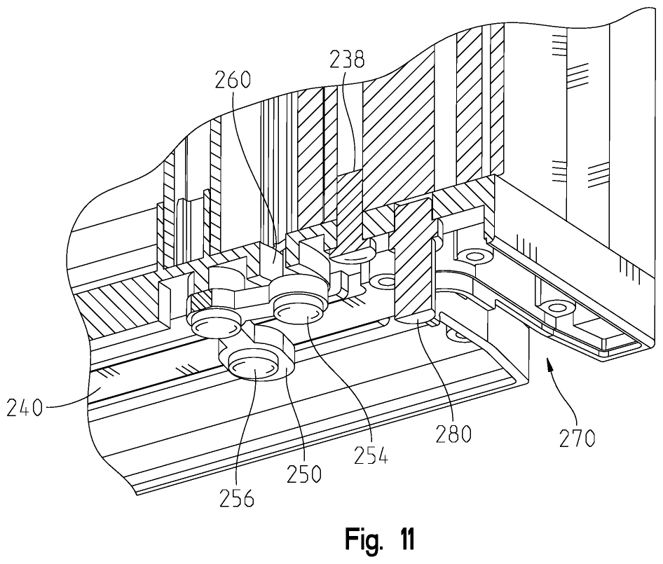

The doors 42, 44 attach, selectively release, and pivot with respect to the cabinet 20 with upper and lower latch assemblies 200, 202 that mate with hinge blocks 50, 52, 54. The latch assemblies 200, 202 are located on transverse sides of the doors 42, 44. In the embodiment described herein, the upper and lower latch assemblies 200, 202 are the same on the doors 42, 44, so only one pair of latch assemblies 200, 202 will be described in detail. The upper latch assembly 200 is connected to the lower latch assembly 202 with a first handle 204 and a second handle 214. The first handle 204 is located in a first handle pocket 206 that extends along a first lateral side 208. The second handle 214 is located in a second handle pocket 216 that extends along a second lateral side 218. The lateral sides 208, 218 connect the transverse sides of the doors, as shown in FIG. 2. As shown in FIGS. 9-13, the handles 204, 214 are molded or extruded with a consistent cross-sectional shape along their length, but other shapes are contemplated. The handles 204, 214 are held between the upper and lower latch assemblies 200, 202 and pivot between a resting position and a displaced position on respective handle axes 220. As can be seen in the FIGS., the handles 204, 214 are only located on the sides of the door, providing an easy to clean front surface that is clear of handles or moving parts.

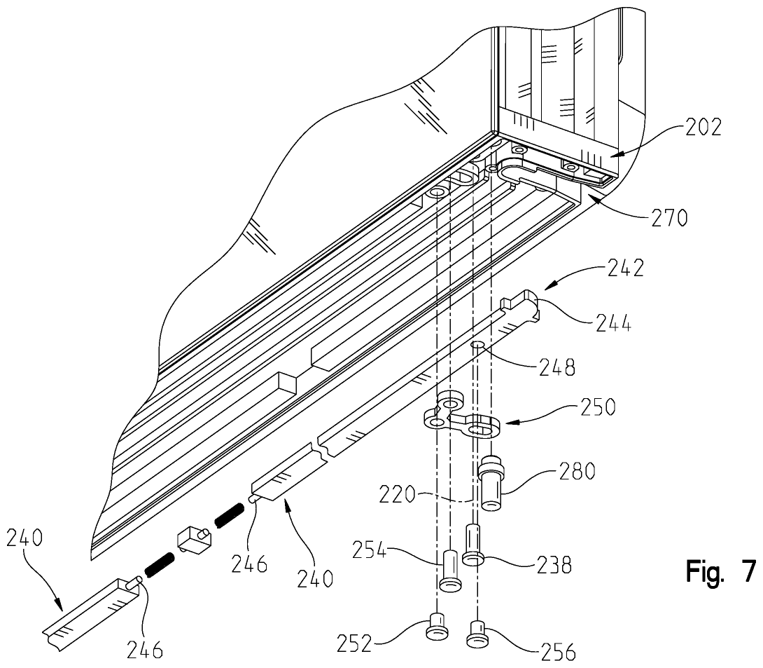

The lower latch assembly 202 differs from the upper latch assembly 200 by including support wheels 228. The support wheels 228 can contact the support surface 172, 122 when the door 42, 44 is closed. Each of the handles are coupled to a lower latch bar 240 and an upper latch bar. The latch bars slide between a closed position and a release position in a direction perpendicular to the handle axes 220 and hinge axes 76, 86. At least one spring biases the latch bars towards the closed position, as shown in FIG. 7. It is contemplated that the handles 204, 214 are biased towards their resting positions through springs or other components that engage with the handles or pivoting link directly.

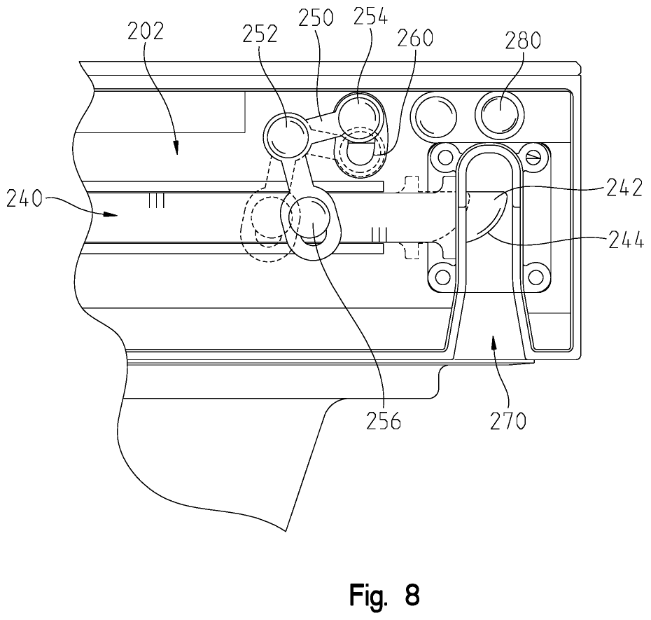

Because upper and lower latch assemblies share features and the latch bars are either mirror symmetrical or identical, the lower latch bar 240 and its connection to the second handle 214 will be described in detail, with the same functions and components applying to the upper latch bar, along with the first handle and its associated latch bars. As shown in FIGS. 7-13, the second handle 214 is retained by a handle pin 238 that allows it to pivot on the handle axis 220 between a resting position, shown in solid lines in FIG. 9 and a displaced position, shown in broken lines. The second handle 214 is coupled to the second latch bar 240 through a pivoting link 250. The pivoting link 250 is connected to the lower latch assembly 202 through a pivot pin 252, which allows the pivoting link 250 to rotate. A first pin 254 extends through one end of the pivoting link 250, through an arcuate aperture 260 and into the second handle 214. This is shown in FIGS. 7-11. A second pin 256 connects the pivoting link 250 to the latch bar 240. The latch bar 240 has a latch end 242 with a ramp surface 244. Opposite the latch end is a blocking end 246. When the handle is moved to the displaced position from the resting position, the latch bar 240 moves from a closed position (shown in solid lines in FIG. 8) to a release position (shown in broken lines). This happens on the same side of both latch assemblies 200, 202. In the closed position, the latch end 242 extends across a latch channel 270 where it can retain hinge pin 164. In the release position, the hinge pin 164 can separate from the latch channel 270. Additionally, the ramp surface 244 allows the hinge pin to move the latch bar 240 from the closed position when the hinge pin enters the latch channel 270 and ramp surface 244 contacts the hinge pin.

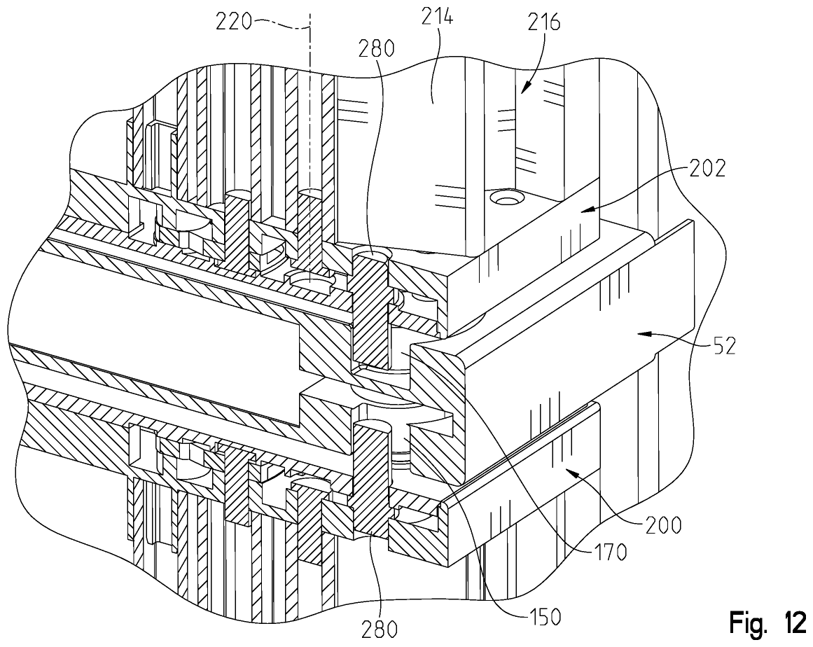

Adjacent each latch channel 270 is a guide pin 280. The guide pins 280 are fixed with respect to the latch assembly 200, 202 and mate with the arcuate guide channels 78, 88, 108, 118, 138, 148, 158, and 168. For example, in FIG. 2, the guide pins 280 on the upper door 42 are located in arcuate guide channels 78 and 158 and the guide pins 280 on the lower door 44 are located in arcuate guide channels 118 and 148. When the doors are closed as shown in FIG. 1, the guide pins 280 are located in the openings 80, 90, 110, 120, 140, 160, and 170. One example of this is shown in FIG. 12.

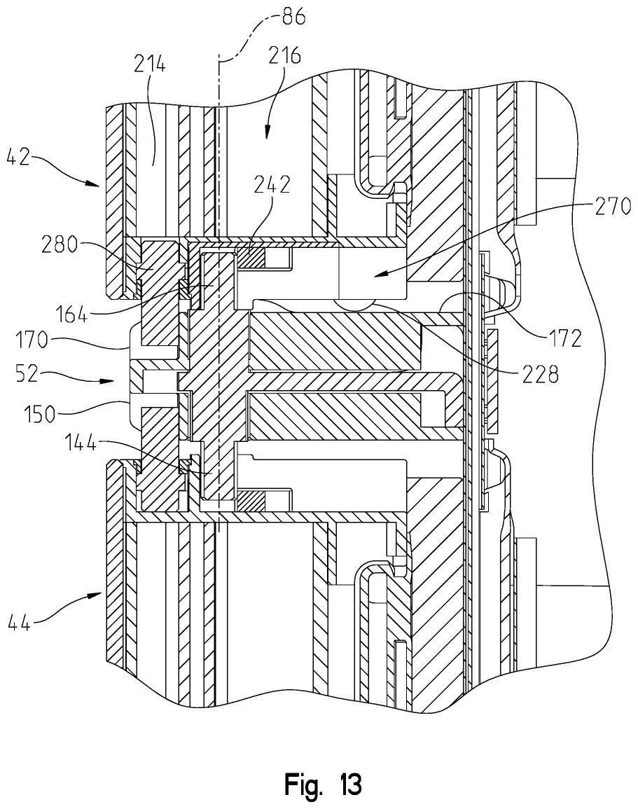

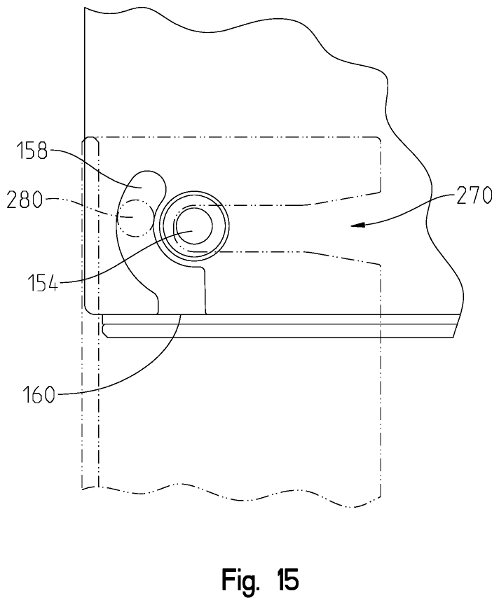

The terms released side and hinged side refer to the operation of the doors 42, 44 and not any specific physical location or component(s). For example, in FIG. 2, the released side of door 42 is on the same side as handle 214 and the hinge side is on the opposite side. On door 44 in FIG. 2, the released side is on the same side as handle 204 and the hinge side is on the opposite side. In the same FIG. 2, the hinge side of door 42 pivots about hinge axis 76 and the hinge side of door 44 pivots about hinge axis 86. When a hinge pin is trapped or otherwise captured in a latch channel by a latch bar, the hinge axis 76, 86 extends through the handle pocket 206, 216. This is true if the door 42, 44 is latched on both sides such as shown in FIGS. 1 and 13, or if one side has been released, such as shown in FIGS. 2 and 15.

When the user opens one of the doors 42, 44, they start by moving the handle 204, 214 on the desired side from the resting position, shown in solid lines in FIG. 9, to the displaced position, shown in broken lines. This causes the first pin 254 to move in the arcuate aperture 260, which in turn causes the pivoting link 250 to rotate. The pivoting link 250 then moves the latch bar 240 from the closed position to a release position, shown in FIG. 8. Moving the handle 204, 214 moves the latch bars in both latch assemblies 200, 202. Once the latch end 242 is clear of the latch channel 270, that side of the door can be pulled away from the cabinet 20. As the door is swung open and begins to pivot on one of the hinge axes 76, 86, the guide pins 280 on the opposite side of the door travel through their respective arcuate channels. As the door pivots open, the guide pins 280 travel around their respective hinge axes 76, 86 at a constant distance. When the guide pins 280 reach the end of the arcuate guide channels, the door 42, 44 is prevented from swinging any further.

The user is prevented from releasing both sides of the door at the same time by the blocking ends 246 on the latch bars 240. When the latch bar 240 is moved to the release position, the blocking end 246 of that latch bar 240 occupies the space that the latch bar on the opposite side would occupy in its release position. Therefore, one latch bar in its release position prevents the latch bar on the opposite side from moving to its release position. If both handles 204, 214 are moved towards their displaced positions at the same time, the blocking ends 246 of both latch bars contact each other to prevent them from both reaching their release positions.

Additional features prevent inadvertent removal of the doors 42, 44. By way of example, when the door 42 is swung open, as is shown in FIG. 2, it pivots on hinge axis 76 and guide pins 280 are located in arcuate channels 78, and 158. In this position, the guide pins 280 prevent the door 42 from being released from hinge axis 76. The latch channel 270 traps the hinge pin 154 in one direction and the arcuate guide channel 158 traps the guide pin 280 in another direction when the door 42 is rotated open. This is shown in FIG. 15, with the door 42 being shown in broken lines with the hinge pin 154, arcuate guide channel 158, and corresponding opening 160 shown in solid lines. In this FIG., the door 42 could only move to the left if the hinge pin 154 was released, but the guide pin 280 is trapped in the guide channel 158, which prevents the hinge pin 154 from moving out of the latch channel 270. The same applies for hinge axis 86, along with the other guide pins and channels.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. An enclosure having a door pivotable about one of two hinge axes, said enclosure comprising:
a cabinet having walls joined to form said enclosure to receive said door;
an upper hinge block affixed to said cabinet and having a first hinge pin located on a first said hinge axis and a second hinge pin located on a second said hinge axis, said upper hinge block having a first arcuate guide channel adjacent to said first hinge pin and a second arcuate guide channel adjacent to said second hinge pin;
a lower hinge block affixed to said cabinet and having a third hinge pin located on said first hinge axis and a fourth hinge pin located on said second hinge axis, said lower hinge block having a third arcuate guide channel adjacent to said third hinge pin and a fourth arcuate guide channel adjacent to said fourth hinge pin;
said door having a first release handle located on a first lateral side and a second release handle located on a second lateral side opposite said first lateral side, said door having a first latch channel for mating with said first hinge pin and a second latch channel for mating with said second hinge pin, said first and second latch channels are on a transverse side that connect said first and second lateral sides, said door having a first guide pin located adjacent said first latch channel and a second guide pin located adjacent said second latch channel, said door having a first latch bar is slidable between a closed position where a portion of said first latch bar extends across said first latch channel and a release position where said first latch channel is clear of said first latch bar, a second latch bar is slidable between a closed position where a portion of said second latch bar extends across said second latch channel and a release position where said second latch channel is clear of said second latch bar; said first and second latch bars are biased towards said closed positions, said door having a third latch channel for mating with said third hinge pin and a fourth latch channel for mating with said fourth hinge pin, said door having a third guide pin located adjacent said third latch channel and a fourth guide pin located adjacent said fourth latch channel, a third latch bar is slidable between a closed position where a portion of said third latch bar extends across said third latch channel and a release position where said third latch channel is clear of said third latch bar, a fourth latch bar is slidable between a closed position where a portion of said fourth latch bar extends across said fourth latch channel and a release position where said fourth latch channel is clear of said fourth latch bar; said third and fourth latch bars are biased towards said closed positions;
said first handle for moving said first and third latch bars between said release position and said closed positions, said second handle for moving said second and fourth latch bars between said release position and said closed position;
said door is pivotable about said second hinge axis when said first release handle moves said first and third latch bars to said release position and said second and fourth hinge pins are captured in corresponding second and fourth latch channels, when said door pivots about said second hinge axis, said second and fourth guide pins rotate around said second and fourth hinge pins in said second and fourth guide channels;
said door is pivotable about said first hinge axis when said second release handle moves said second and fourth latch bars to said release position and said first and third hinge pins are captured in corresponding first and third latch channels, when said door pivots about said first hinge axis, said first and third guide pins rotate around said first hinge pin in said first and third guide channels.

2. The enclosure of claim 1, wherein said first release handle is located in a first handle pocket and said second release handle is located in a second handle pocket, said first hinge axis extends through said first handle pocket when said first and third hinge pins are captured in said first and third latch channels, said second hinge axis extends through said second handle pocket when said second and fourth hinge pins are captured in said second and fourth latch channels.

3. The enclosure of claim 1, wherein said first and second latch bars are coupled to each other such that only one of said latch bars can be in said release position at a time, said first latch bar contacts said second latch bar when one of said latch bars is in said release position and another of said latch bars is moved from its said closed position.

4. The enclosure of claim 1, wherein said first and second release handles are formed from an extrusion.

5. The enclosure of claim 1, wherein said door comprises a plurality of pivoting links, said release handles are coupled to said latch bars through said pivoting links.

6. The enclosure of claim 1, wherein said latch bars each have a ramped surface located on a corresponding latch end.

7. The enclosure of claim 1, wherein said latch bars slidable in a direction perpendicular to said first and second hinge axes.

8. The enclosure of claim 1, further comprising a spring between said first and second latch bars and a spring between said third and fourth latch bars to bias each said latch bar towards said closed position.

9. An enclosure comprising:
a cabinet having an opening, said cabinet having a first pair of hinge pins affixed thereto and located on a first hinge axis on one side of said opening and a second pair of hinge pins affixed to said cabinet and located on a second hinge axis on an opposite side of said opening, said first hinge axis is parallel to said second hinge axis, said first and second pairs of hinge pins having corresponding pairs of arcuate guide channels, said first pair of arcuate guide channels spaced farther from said second pair of arcuate guide channels than said first and second hinge axes, each said arcuate guide channel having a constant radial distance from its corresponding hinge axis, each said arcuate guide channel having an opening;
a door for pivoting about said first or second hinge axis, said door having a first release handle extending along a first lateral side and a second release handle extending along a second lateral side, said first release handle coupled to a first pair of latch bars, said second release handle coupled to a second pair of latch bars, each said latch bar movable between a closed position and a release position, said closed position defined by said latch bar extending across a corresponding latch channel, said release position defined by said latch channel, said door having a guide pin adjacent each said latch channel;
when said door is secured to said first and second pairs of hinge pins, said door is mated to said cabinet and overlays said opening of said cabinet and each said guide pin is located in a corresponding said opening of each said arcuate guide channel;
when said door is detached from one of said pairs of hinge pins, said door is pivotable about the other of said pairs of hinge pins.

10. The enclosure of claim 9, wherein said latch bars are slidable in a direction perpendicular to the hinge axes.

11. The enclosure of claim 9, when said door is pivoted open, one of said guide pins enters a corresponding arcuate guide channel.

12. The enclosure of claim 9, wherein one of said hinge axes extends through one of said handle pockets.

13. The enclosure of claim 9, wherein one of said latch bars contacts a second said latch bar when one of said latch bars is in its said release position and another of said latch bars is moved from its said closed position.

14. The enclosure of claim 9, further comprising a spring between said first pair of latch bars and a spring between said second pair of latch bars to bias each said latch bar towards said closed position.

15. An enclosure comprising:
a cabinet having a first hinge pin located on a first hinge axis and a second hinge pin located on a second hinge axis, said first hinge axis is parallel to said second hinge axis, said first and second hinge pins having corresponding arcuate guide channels adjacent thereto, said first arcuate guide channel spaced farther from said second arcuate guide channel than said first hinge axis is spaced from said second hinge axis, each said arcuate guide channel having a corresponding opening;
a door pivotable about either of said hinge axes, said door operable between a latched position defined by said door being secured to said first and second hinge pins and an opened position defined by said door being free from one of said hinge pins and pivotable about the other of said hinge pins;
said door having a first release handle located on a first lateral side, said first release handle coupled to a first latch bar, said first latch bar is slidable between a closed position defined by a portion of said first latch bar extending across a first latch channel for capturing said first hinge pin and a release position defined by said portion of said first latch bar clear of said first latch channel to allow said first hinge pin to escape said first latch channel, said door having a second release handle located on a second lateral side, said second release handle coupled to a second latch bar, said second latch bar is slidable between a closed position defined by a portion of said second latch bar extending across a second latch channel for capturing said second hinge pin and a release position defined by said portion of said second latch bar clear of said second latch channel to allow said second hinge pin to escape said second latch channel;
said door having a first guide pin adjacent said first latch channel and a second guide pin adjacent said second latch channel, each said guide pin for engaging with a corresponding arcuate guide channel when said door is pivoted about an adjacent said hinge axis.

16. The enclosure of claim 15, wherein one of said latch bars contacts a second said latch bar when one of said latch bars is in its said release position and another of said latch bars is moved from its said closed position.

17. The enclosure of claim 15, further comprising a spring between said first and second latch bars to bias each said latch bar towards its said closed position.
